(19) United States
(12) Patent Application Publication
(10) Pub. No.: US 2004/0139145 A1
(43) Pub. Date: Jul. 15, 2004

(54) Method and apparatus for scalable distributed storage

(76) Inventors: Gigy Bar-or, Ramat Gan (IL); Nir Peleg, Be'er Yacov (IL); Amnon Strasser, Tel Aviv (IL)

Correspondence Address: SUGHRUE MION, PLLC, 2100 PENNSYLVANIA AVENUE, N.W., SUITE 800, WASHINGTON, DC, 20037, US

(21) Appl. No.: 10/451,180

(22) PCT Filed: Dec. 21, 2000
(86) PCT No.: PCT/US00/34253

(51) Int. Cl. G06F 15/16

(52) U.S. Cl. 709/200

(57) ABSTRACT

Independent nodes (66) providing storage services can be networked together, such that client devices (60, 61) can be attached to any independent node (66c, 66d), while independent nodes (66) identify themselves to client devices (60, 61) uniformly. Each independent node (66) would have the same name, address or other identification data with respect to each client device (60, 61). When data stored in a specific independent node (66) are accessed by a client device (60, 61) connected to a different independent node (66c, 66d), the request is forwarded to the independent node that where the requested data is stored. That independent node (66) can either respond to the client device (60, 61) directly or forward the response to another independent node (66) which can send the response back to the client device (60, 61).

### BACKGROUND OF THE INVENTION

1. Technical Field of the Invention

This invention is related to a method and apparatus for scalable distributed storage. In particular, independent nodes providing storage services are networked together, such that client devices can be attached to any independent node, while independent nodes identify themselves to client devices uniformly. Each independent node would have the identical name, address or other identification data with respect to each client device.

2. Description of the Related Art

There will now be provided a discussion of various topics to provide a proper foundation for understanding the invention.

In order for a client device to be able to access to multiple servers running different operating systems, either the client device supports the file sharing protocol of each operating system or the server supports the file sharing protocol of each client device. Software that adds this capability is very common and allows interoperability between Windows®, Macintosh®, NetWare® and UNIX platforms. TABLE 1 lists several common operating systems and their respective transport and file sharing protocols for networking environments.

TABLE 1

| Operating | Transport | File Sharing |
|---|---|---|
| System | Protocol | Protocol |
| DOS | NETBIOS | SMB |
| WINDOWS | NETBEUI | SMB, CIFS |
| NETWARE | IPX | NCP |
| MACINTOSH | APPLETALK | AFP |
| UNIX | TCP/IP | NFS |

A Storage Area Network (SAN) system is a back-end network that uses peripheral channels to connect storage devices. Typically, the peripheral channels are Small Computer System Interface (SCSI), Serial Storage Architecture (SSA), Enterprise Systems Connection (ESCON) and Fibre Channel. SAN devices are usually dedicated high-bandwidth systems that handle traffic between servers and storage assets. Data objects on a SAN system are sets of logical disk volumes above which higher level object semantics can be implemented on specific application servers.

Both centralized SANs and distributed SANs are currently used. A centralized SAN ties multiple hosts into a single storage system. The storage system is usually a Redundant Array of Independent Disks (RAID) device with large amounts of cache and redundant power supplies. Typically, this centralized storage architecture ties a server cluster together for fault tolerance (i.e., if one server fails, another server can take over). Centralized SAN also provides simplified sharing of data between multiple servers, and further provides multiple servers the capability to perform the work on the shared data.

Referring to FIG. 1, a centralized SAN system is illustrated. The applications servers 1,2 and the mainframe computer 6 are connected to the disk array 4 via several peripheral channels 8-10. As described above, the peripheral channels may use SCSI, SSA, ESCON or Fibre Channel protocols to transfer data between the disk array 4 and the applications servers 1,2.

A distributed SAN system connects multiple hosts with multiple storage systems. Referring to FIG. 2, a distributed SAN system is illustrated. Several applications servers 1-3 are connected to a switch 7, which is also connected to several disk arrays 4,5. The switch 7 handles the transfer of data between the multiple disk arrays 4,5 and the applications servers 1-3 via the peripheral channels 8-12. Of course, SAN systems are not limited to only using disk arrays for data storage. For example, a distributed SAN system could be simultaneously connected to both single disk storage systems and disk array storage systems. In addition, a distributed SAN system can be constructed from hubs (which connect to the storage devices via loops), or a combination of hubs and switches.

Referring to FIG. 3, the data path of data objects transferred between an applications server 15 and the disk storage 18 will be described. As noted above, data objects transferred in a SAN system are logical disk volumes. When a data request is received at the disk storage 18 for an identified logical disk volume, the disk storage 18 sends out the volume over peripheral channel 20 into the SAN network 19. When the logical disk volume arrives at the applications server 15, the file manager 17 handles the high-level object semantics necessary to supply the requested data to the software application 16.

A Network Attached Storage (NAS) system is connected to a front-end communications network, just like a file server. Typically, the communications protocol is Ethernet, TCP/IP or FFP, but other lesser-used protocols are not excluded. A NAS system does not rely upon a complete operating system for its functionality. Instead, a slimmed-down micro-kernel targeted for file management is used. Traditional Local Area Network (LAN) protocols such as NFS (UNIX), SMB/CIPS (DOS/Windows) and NCP (NetWare) are examples of slimmed-down operating systems used for file management on a NAS system. Devices in a NAS system typically attach to a LAN and allow sets of users to retrieve and share files that may span over multiple operating system environments.

Referring to FIG. 4, a NAS system is illustrated. Several clients 21-22 are connected to a hub 25. The hub 25 is connected to a NAS server 23. The NAS server 23 communicates with a disk array 24 to retrieve data for the clients 21-22 or to store data for the clients 21-22. LAN channels 26-28 realize connections between the NAS server 23, the hub 25 and the clients 21-22.

Referring to FIG. 5, the data path of data objects transferred between a client 33 and the disk storage 32 will be described. A NAS system exports higher level objects (i.e., files) to the LAN for use by the client systems attached to the LAN. A request for a file stored on the NAS server 30 is received from the NAS network 35. The file manager 31 searches the disk storage 32 for the file, and if located, outputs the file to the NAS network 35 over the LAN channel 36. When the file arrives at the client 33, the software application 34 is able to manipulate the file.

An advantage of the NAS system is that adding or removing a NAS system is like adding or removing any network node. In general, a SAN system (e.g., a channel-attached storage system) must be brought down in order to reconfigure it. Another advantage of a NAS system is that application servers are not involved with management functions, such as volume management, and can access the stored data as files. However, NAS systems are subject to the erratic behavior and overhead of the network.

Catering for the demand for higher capacity and bandwidth calls for scaling up existing solutions by orders of magnitude. Scalability, however, is not easily achieved. NAS vendors typically build centralized systems, which are limited in size by definition. Vendors often misrepresent system growth as scalability. The limited total capacity and bandwidth of any NAS device imposes serious limitations on clients. As more clients are added to the system, more NAS devices are required to accommodate for the increasing bandwidth. This is where the existing NAS architectures get in the way: using multiple NAS devices, incapable of sharing data among them, dictates that data should be duplicated. The total amount of data that such system can handle is therefore not greater than that of a single NAS device, since data cannot be shared and needs to be duplicated once per each device (non-shared data does not have to be duplicated). Another compelling reason to duplicate data is that many clients require the same data, and a single NAS device does not have enough bandwidth to support all the clients (e.g., multiple users wishing to view the latest CNN news on the Internet).

SAN vendors, on the other hand, totally miss out on scalability since the service they provide to their clients is essentially a big disk. The fact that multiple such “disks” (SAN systems) can be attached to a single server creates a misleading representation of “scalability,” while in reality the server itself soon becomes the bottleneck for the same reason a NAS device suffers from bottleneck problems.

Traditional SAN and NAS solutions have been designed to meet the requirements imposed by the “narrow band world.” With the accelerated deployment of optical networks at the core level, the communication bottleneck is being shifted to the edge of the network.

Trends studied by various analysts show that future networked storage products will have to meet challenges set forward by the following factors:

Broadband networks deployment

Content delivery networks

Data-intensive applications

New classes of Internet-based services

Referring to FIG. 6, the conventional approach in addressing these architectural limitations is by creating different “storage islands,” each storing different content. Each of the servers 40-43 has its own mass storage island 44-47. Different users are sent to different mass storage islands, based on the location of the content required. This brute force approach results in inefficiencies leading to significant increase in the cost per shared megabyte of storage.

### SUMMARY OF THE INVENTION

The invention has been made in view of the above circumstances and to overcome the above problems and limitations of the prior art.

Additional aspects and advantages of the invention will be set forth in part in the description that follows and in part will be obvious from the description, or may be learned by practice of the invention. The aspects and advantages of the invention may be realized and attained by means of the instrumentalities and combinations particularly pointed out in the appended claims.

A first aspect of the invention provides a scalable distributed storage apparatus with a network. The apparatus further includes independent nodes connected to each other through the network, and each independent node has a storage device. Each independent node responds with the same identifier when a client device attaches to any one of the independent nodes.

A second aspect of the invention provides a scalable distributed storage apparatus with a network, and the apparatus includes several independent computing means connected to each other through the network, several network storage means connected to independent computing means through the network. Bach independent computing means responds with the same identifier when a client means attaches to any one of the independent computing means.

A third aspect of the invention provides a method of handling data on a scalable distributed storage apparatus having several independent nodes. The method includes attaching a client device to an independent node, and transmitting a predetermined identifier to the client device when the client device attaches to the independent node, and requesting data from the scalable distributed storage apparatus. The method further includes forwarding the data request to the independent nodes, receiving and caching the requested data at the independent node to which the requesting client device is attached, and notifying the independent nodes of the location of the cached requested data.

A fourth aspect of the invention provides a computer program product for processing data requests on a scalable distributed storage apparatus. The computer program product has software instructions for enabling an independent node to perform predetermined operations, and a computer readable medium bearing the software instructions. The predetermined instructions include attaching a client device to an independent node, and transmitting a predetermined identifier to the client device when the client device attaches to the independent node, and requesting data from the scalable distributed storage apparatus. The predetermined instructions further include forwarding the data request to the independent nodes, receiving and caching the requested data at the independent node to which the requesting client device is attached, and notifying the independent nodes of the location of the cached requested data.

A fifth aspect of the invention provides an executable program for an independent node in a scalable distributed storage apparatus. The executable program includes a first executable portion for attaching a client device to an independent node, and a second executable portion for transmitting a predetermined identifier to the client device when the client device attaches to the independent node, and a third executable portion for requesting data from the scalable distributed storage apparatus. The predetermined instructions further include a fourth executable portion for forwarding the data request to the independent nodes, a fifth executable portion for receiving and caching the requested data at the independent node to which the requesting client device is attached, and a sixth executable portion for notifying the independent nodes of the location of the cached requested data.

A sixth aspect of the invention provides an executable program for an independent node in a scalable distributed storage apparatus. The executable program includes software means for attaching a client device to an independent node, and software means for transmitting a predetermined identifier to the client device when the client device attaches to the independent node, and software means for requesting data from the scalable distributed storage apparatus. The predetermined instructions further include software means for forwarding the data request to the independent nodes, software means for receiving and caching the requested data at the independent node to which the requesting client device is attached, and software means for notifying the independent nodes of the location of the cached requested data.

A seventh aspect of the invention provides a computer system adapted to storing data from a plurality of storage systems on a storage medium. The computer system has a processor and a memory having software instructions adapted for enabling an independent node to perform predetermined operations, and a computer readable medium bearing the software instructions. The software instructions are adapted to enable attaching a client device to an independent node, and to enable transmitting a predetermined identifier to the client device when the client device attaches to the independent node, and to enable requesting data from the scalable distributed storage apparatus. The software instructions are further adapted to enable forwarding the data request to the independent nodes, to enable receiving and caching the requested data at the independent node to which the requesting client device is attached, and to enable notifying the independent nodes of the location of the cached requested data.

A eighth aspect of the invention provides a method of handling data on a scalable distributed storage apparatus having several independent nodes. Multiple client devices can attach to the independent nodes to store data on the scalable distributed storage apparatus. The method comprises attaching a client device to an independent node, and transmitting a predetermined identifier to the client device from the independent node. The method further comprises receiving a new data set input from the client device attached to the independent node, and determining whether the new data set is new data to be stored or an update to previously stored data. Based on that determination, the method further comprises storing the new data set input on the scalable distributed storage apparatus, if it is new data to be stored, or updating the previously stored data on the scalable distributed storage apparatus, if the new data set is an update to previously stored data. The method also comprises transmitting a notification to the attached client device if the storing of the new data set was successful.

A ninth aspect of the invention provides a computer program product for processing data requests on a scalable distributed storage apparatus having several independent nodes. Multiple client devices can attach to the independent nodes to store data on the scalable distributed storage apparatus. The computer program product includes software instructions for enabling an independent node to perform predetermined operations, and a computer readable medium bearing the software instructions. The predetermined operations include attaching a client device to an independent node, and transmitting a predetermined identifier to the client device from the independent node. The predetermined operations further include receiving a new data set input from the client device attached to the independent node. The method further comprises determining whether the new data set is new data to be stored or an update to previously stored data. Based on that determination, the predetermined operations further include storing the new data set input on the scalable distributed storage apparatus, if it is new data to be stored, or updating the previously stored data on the scalable distributed storage apparatus, if the new data set is an update to previously stored data. The predetermined operations further include transmitting a notification to the attached client device if the storing of the new data set wag successful.

A tenth aspect of the invention provides an executable program for an independent node in a scalable distributed storage apparatus. The executable program includes executable portions for executing on an independent node. The executable program comprises a first executable portion for attaching a client device to an independent node, and a second executable portion for transmitting a predetermined identifier to the client device from the independent node. The executable program further includes a third executable portion for receiving a new data set input from the client device attached to the independent node. The executable program further includes a fourth executable portion for determining whether the new data set is new data to be stored or an update to previously stored data. Based on that determination, the fourth executable portion stores the new data set input on the scalable distributed storage apparatus, if it is new data to be stored, or updating the previously stored data on the scalable distributed storage apparatus, if the new data set is an update to previously stored data. The executable program further includes a fifth executable portion for transmitting a notification to the attached client device if the storing of the new data set was successful.

An eleventh aspect of the invention provides an executable program for an independent node in a scalable distributed storage apparatus. The executable program includes software means for executing on an independent node. The executable program comprises software means for attaching a client device to an independent node, and a software means for transmitting a predetermined identifier to the client device from the independent node. The executable program further includes software means for receiving a new data set input from the client device attached to the independent node. The executable program further includes software means for determining whether the new data set is new data to be stored or an update to previously stored data. Based on that determination, the software means stores the new data set input on the scalable distributed storage apparatus, if it is new data to be stored, or updating the previously stored data on the scalable distributed storage apparatus, if the new data set is an update to previously stored data. The executable program further includes software means for transmitting a notification to the attached client device if the storing of the new data set was successful.

A twelfth aspect of the invention provides a computer system adapted to storing data from a plurality of storage systems on a storage medium. The computer system includes a processor, and a memory bearing software instructions. The software instructions are adapted to attach a client device to an independent node, and transmitting a predetermined identifier to the client device from the independent node. The software instructions are further adapted to receive a new data set input from the client device attached to the independent node. The software instructions are further adapted to determine whether the new data set is new data to be stored or an update to previously stored data. Based on that determination, the software instructions are further adapted to store the new data set input on the scalable distributed storage apparatus, if it is new data to be stored, or update the previously stored data on the scalable distributed storage apparatus, if the new data set is an update to previously stored data. The software instructions are further adapted to transmit a notification to the attached client device if the storing of the new data set was successful.

The above aspects and advantages of the invention will become apparent from the following detailed description and with reference to the accompanying drawing figures.

### BRIEF DESCRIPTION OF THE DRAWINGS

The accompanying drawings, which are incorporated in and constitute a part of this specification, illustrate the invention and, together with the written description, serve to explain the aspects, advantages and principles of the invention. In the drawings,

FIG. 1 illustrates a centralized SAN system with several servers and a disk array;

FIG. 2 illustrates a distributed SAN system with several servers and multiple disk arrays;

FIG. 3 illustrates how data objects are passed from disk storage to the application on a SAN system;

FIG. 4 illustrates a NAS system with several clients and a NAS server;

FIG. 5 illustrates how data objects are passed from disk storage to the application on a NAS system;

FIG. 6 illustrates a conventional network comprised of servers attached to mass storage islands;

FIG. 7 illustrates a network according to an aspect of the invention where the mass storage islands are condensed together;

FIG. 8 illustrates a network according to an aspect of the invention showing the data pathways between mass storage devices;

FIG. 9 illustrates a network according to a second aspect of the invention showing the data pathways between mass storage devices;

FIGS. 10A-10B illustrate the basic process flow for attaching a client device to a network and retrieving data therefrom; and

FIGS. 11A-11B illustrate the basic process flow for attaching a client device to a network and storing data thereto.

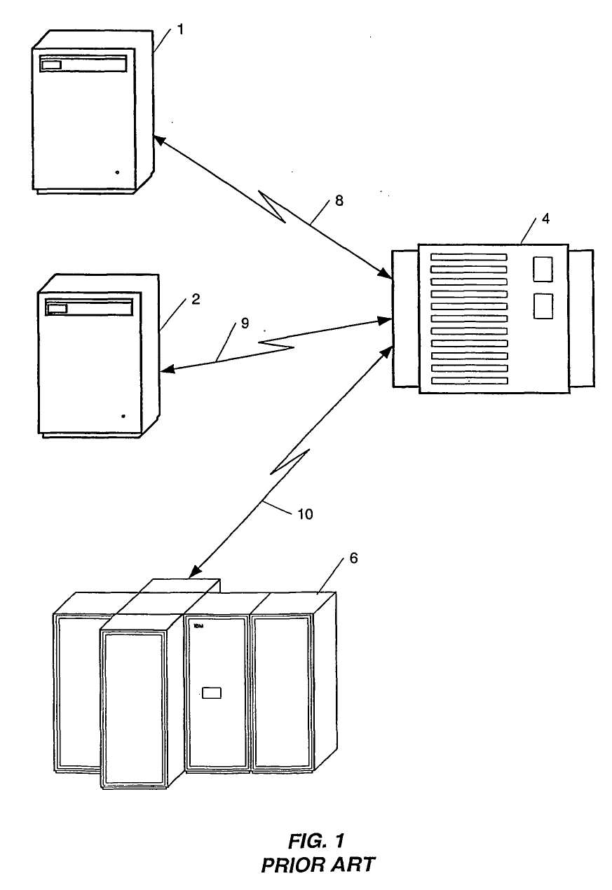

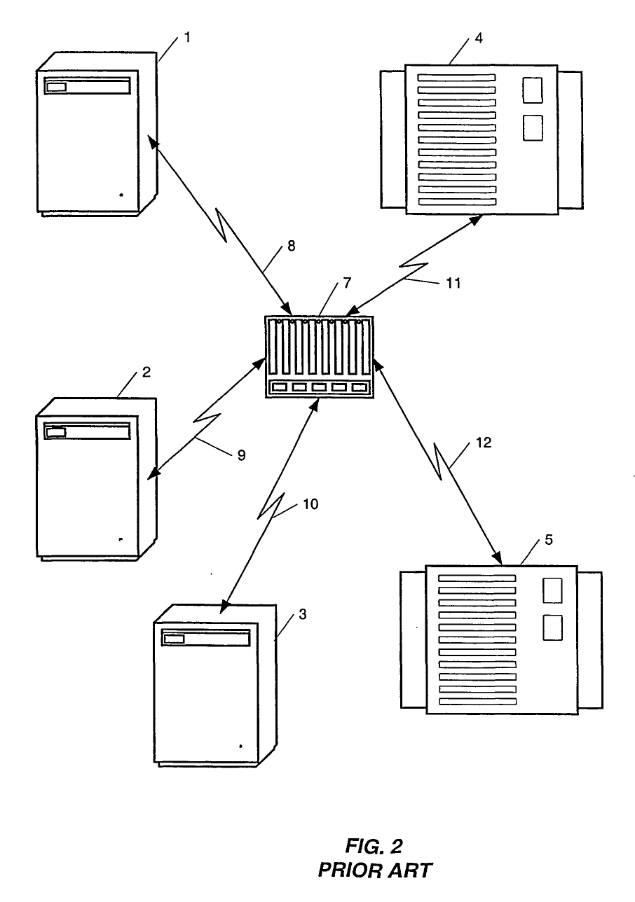

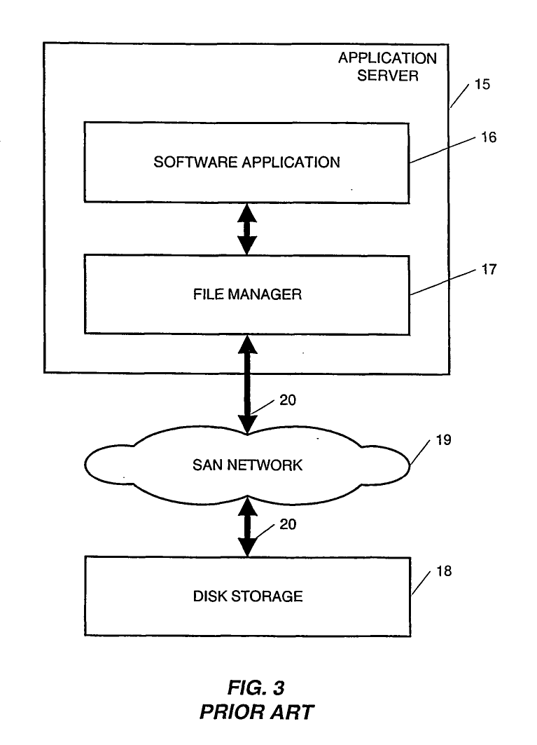

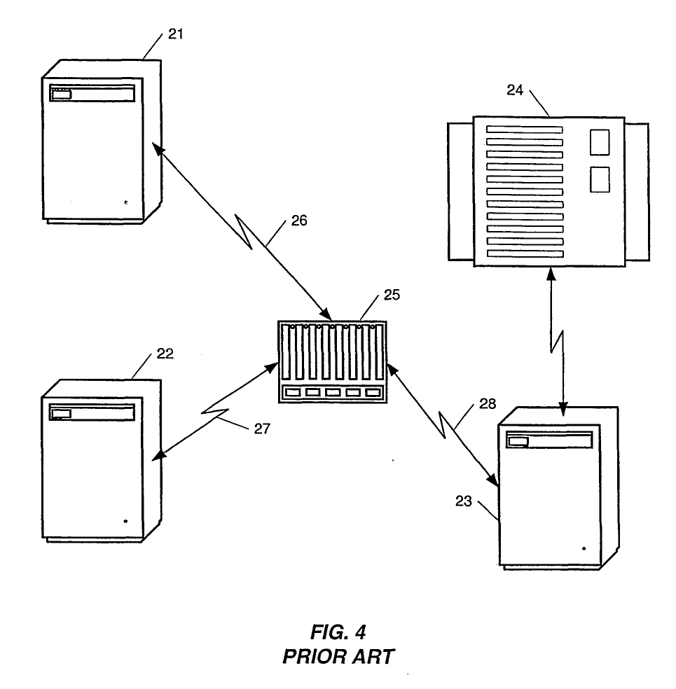

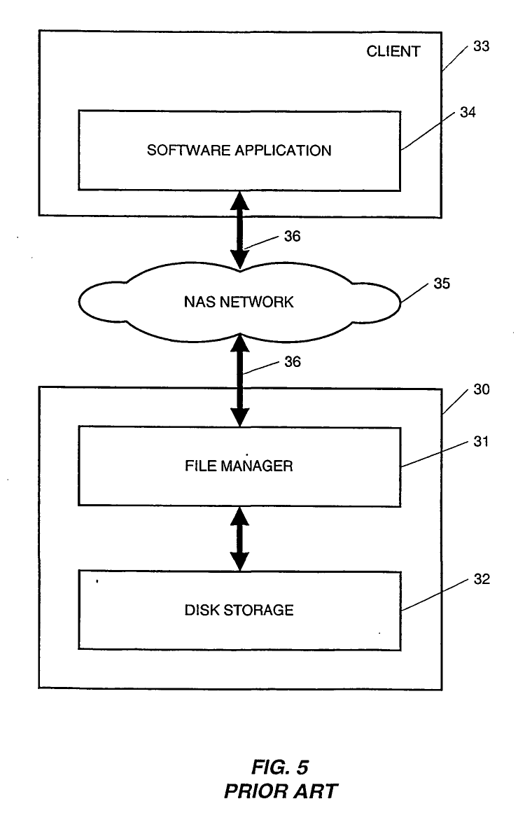

### DETAILED DESCRIPTION OF THE INVENTION

Prior to describing the aspects of the invention, some details concerning the prior art will be provided to facilitate the reader's understanding of the invention and to set forth the meaning of various terms.

As used herein, the term “computer system” encompasses the widest possible meaning and includes, but is not limited to, standalone processors, networked processors, mainframe processors, and processors in a client/server relationship. The term “computer system” is to be understood to include at least a memory and a processor. In general, the memory will store, at one time or another, at least portions of executable program code, and the processor will execute one or more of the instructions included in that executable program code.

As used herein, the term “embedded computer system” includes, but is not limited to, an embedded central processor and memory bearing object code instructions. Examples of embedded computer systems include, but are not limited to, personal digital assistants, cellular phones and digital cameras. In general, any device or appliance that uses a central processor, no matter how primitive, to control its functions can be labeled has having an embedded computer system. The embedded central processor will execute one or more of the object code instructions that are stored on the memory. The embedded computer system can include cache memory, input/output devices and other peripherals.

As used herein the terms “predetermined operations,” the term “computer system software” and the term “executable code” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

As used herein, the terms “media,” “medium” or “computer-readable media” include, but is not limited to, a diskette, a tape, a compact disc, an integrated circuit, a cartridge, a remote transmission via a communications circuit, or any other similar medium useable by computers. For example, to distribute computer system software, the supplier might provide a diskette or might transmit the instructions for performing predetermined operations in some form via satellite transmission, via a direct telephone link, or via the Internet.

Although computer system software might be “written on” a diskette, “stored in” an integrated circuit, or “carried over” a communications circuit, it will be appreciated that, for the purposes of this discussion, the computer usable medium will be referred to as “bearing” the instructions for performing predetermined operations. Thus, the term “bearing” is intended to encompass the above and all equivalent ways in which instructions for performing predetermined operations are associated with a computer usable medium.

Therefore, for the sake of simplicity, the term “program product” is hereafter used to refer to a computer-readable medium, as defined above, which bears instructions for performing predetermined operations in any form.

As used herein, a “redundant array of independent disks” (RAID) is a disk subsystem that increases performance and/or provides fault tolerance. RAID is a set of two or more hard disks and a specialized disk controller that contains the RAID functionality.

A detailed description of the aspects of the invention will now be given referring to the accompanying drawings.

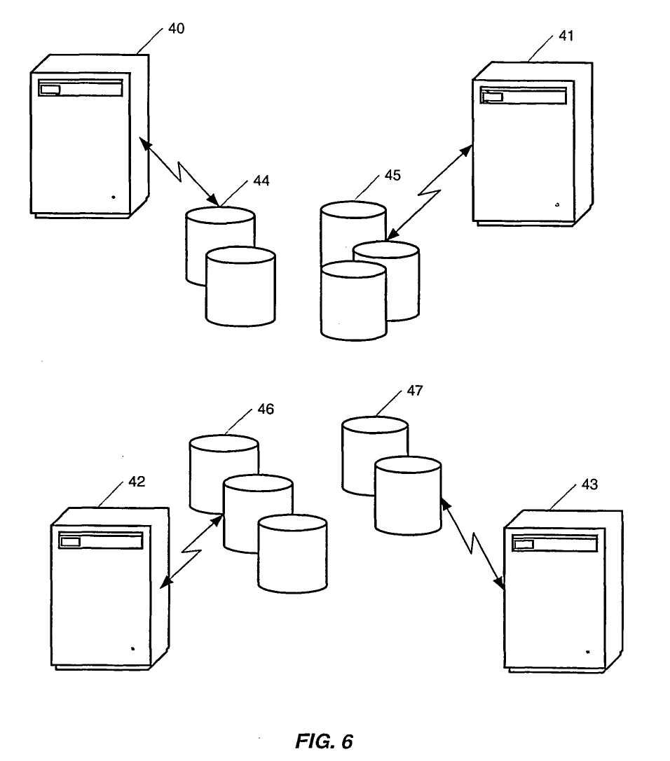

As described above and illustrated in FIG. 6, the creation of different “mass storage islands,” each storing different content, is the conventional approach in addressing architectural limitations. Each of the servers 40-43 has its own mass storage island 44-47. Different users are sent to different mass storage islands, based on the location of the content required. This brute force approach results in inefficiencies leading to significant increase in the cost per shared megabyte of storage.

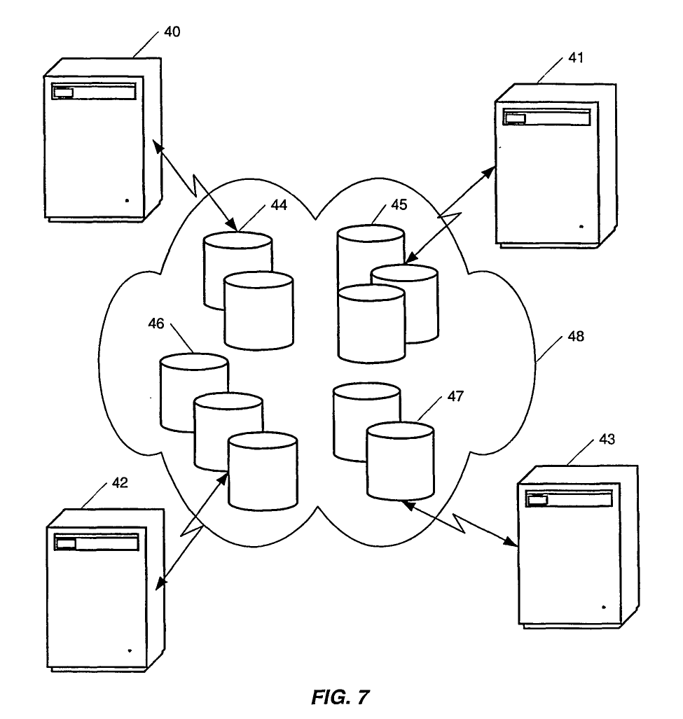

Referring to FIG. 7, the present invention overcomes the inefficiencies of the conventional approach by integrating the different mass storage islands into a scalable distributed storage apparatus 48. The present invention provides for easier management and lower total cost of ownership. The bandwidth and storage capacity of the scalable distributed storage apparatus 48 can be easily increased simply be adding additional nodes to service more clients. Most importantly, the scalable distributed storage apparatus 48 avoids the data duplication of the conventional mass storage islands.

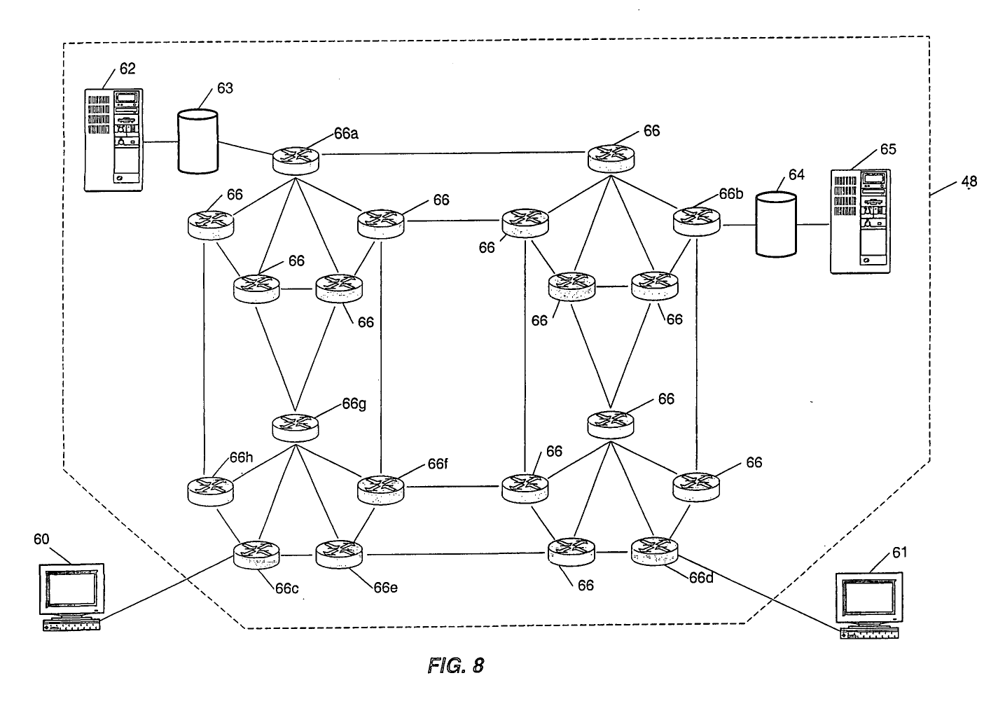

Referring to FIG. 8, an embodiment of the present invention is illustrated. The present invention is comprised of a plurality of independent nodes 66 networked together to form a scalable distributed storage apparatus 48. The independent nodes 66 can be networked together in a variety of ways, and the network scheme illustrated in FIG. 8 is not limiting in any fashion. For the sake of clarity, each independent node 66 in FIG. 8 does not show all the components that may comprise an independent node. Two of the independent nodes 66a,66b are illustrated with additional components. In the embodiment illustrated, the two independent nodes further comprise a server 62,65 and a mass storage device 63,64. At the very least, each independent node should comprise some sort of mass storage device. The scalable distributed storage apparatus 48 can be accessed at any of the independent nodes 66 by one or a plurality of client devices 60,61.

The client devices 60,61 may simply dumb terminals lacking any processing power, a full computer system having vast amounts of processing power, or something in between, such as a network terminal having some memory storage for programs and scratchpad purposes. The function of a client device attached to the scalable distributed storage apparatus 48 is to provide a user with the ability to retrieve and store data in the scalable distributed storage apparatus 48.

Each independent node uniformly responds to each client device that attaches to the scalable distributed storage apparatus 48 with an identifier unique to the scalable distributed storage apparatus 48. The client device is the initiator of the request for the predetermined identifier. The client device uses the predetermined identifier in order to access the scalable distributed storage apparatus for data storage operations. The same predetermined identifier is used independently of the accessed independent node. The independent nodes use the same predetermined identifier when responding to the client requests in order to identify itself. Thus, from the perspective of the client device, there does not appear to be any difference to which independent node it attaches. In addition, the client device does not need to know different addresses in order to be able to reach different mass storage islands. Each independent node will respond with the identical identifier to any client device that attaches to the scalable distributed storage apparatus 48. Each independent node will have the same name, address or other identification address (e.g., DNS address).

Preferably, each independent node is a server, and several types of network protocols can be used to communicate over the scalable distributed storage apparatus 48 between the plurality of independent nodes 66. Each independent node 66 further comprises the necessary interface equipment for facilitating message and/or data transfer between the independent nodes 66. Preferably, the communications protocol between the client devices 60,61 and the independent nodes 66 is the InfiniBand protocol, but other protocols can be used as well. The InfiniBand protocol is the preferred communications protocol between the independent nodes 66 as well.

Preferably, each independent node further comprises at least one storage device for storing data and for caching data received from other independent nodes. In general, the storage device is a hard disk device. Current hard disk devices, having storage capacities ranging in the gigabyte range, are well suited to the present invention. The storage device may also comprise a RAID device to allow for greater system availability. Other types of storage devices, such as optical drives; tape storage and semiconductor memory can be used as well.

The storage devices of the present invention do not have be an integral part of an independent node. A network storage device may be connected to any point in the network of independent nodes. The network storage device can be attached to an independent node, or the network storage device may be the node itself. Preferably, the network storage device is comprised of hard disk storage or a RAID device as described above. The preferred communications protocol between the independent nodes and the network storage device is the InfiniBand protocol, although other protocols may be used as well.

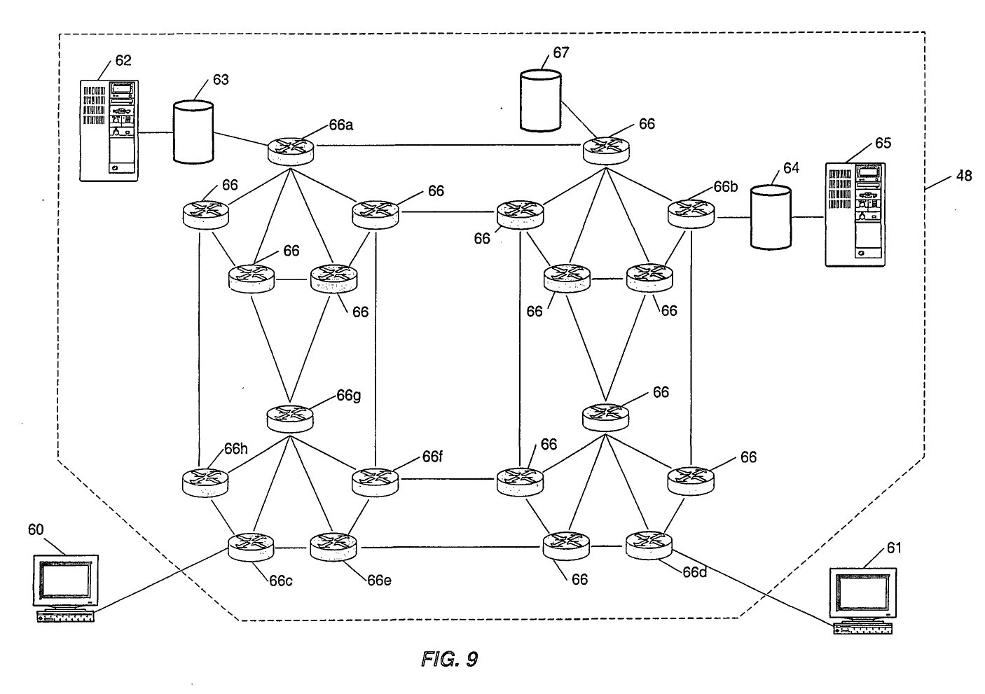

Referring to FIG. 9, the scalable distributed storage apparatus 48 handles a data retrieval request from a client device in the following manner. The data retrieval request is routed from the independent node 66c attached to the client device 60 to the independent node 66b storing the requested data. While in this example it is assumed that a single independent node is storing the requested data, in actual practice a single independent node or several independent nodes may be caching the data that corresponds to the data retrieval request. The present invention is not limited in that the requested data may be stored at one independent node 66 in the scalable distributed storage apparatus 48, while copies of the requested data may be cached at several independent nodes 66 spread throughout the scalable distributed storage apparatus 48. At the independent node 66b, the requested data is retrieved from the mass storage device 64 and is delivered through the scalable distributed storage apparatus 48 back to the independent node 66c that received the initial data retrieval request from a client device 60. The retrieved data is cached at that independent node 66c as well. Thus, if the client device 60 again requests the identical data, it will be retrieved from the memory cache of the independent node 66c that is attached to the client device, rather than the data retrieval request traversing the scalable distributed storage apparatus 48 to other independent nodes.

Any independent node that is caching data can perform several functions to inform other independent nodes that it is caching a particular data set. An independent node caching a particular data set can broadcast a data caching notification to all of the independent nodes. That is, all of the independent nodes in the scalable distributed storage apparatus 48 will receive a message describing the particulars of the data that is current cached at the independent node that sent the message. Alternatively, an independent node caching a particular data set can broadcast a data caching notification only to a subset of independent nodes. For example, a independent node 66c may only broadcast the data caching notification to the independent nodes 66e,66g,66h to which it has a direct connection. In addition, a independent node 66c may only broadcast the data caching notification to the independent nodes that are within “two hops” (i.e., 66f) of the independent node broadcasting the notification. Also, an independent node may broadcast the data caching notification to a random subset of the independent nodes.

The data set itself may be cached only at particular nodes throughout the network. There is no requirement that each independent node have the same data sets as all the other independent nodes. Each independent node maintains a data list describing the data stored at the independent node, as well as the data cached at the independent node. The data list is updated when new data is stored or deleted from the independent node, when new data is cached at the independent node, and when cached data is either updated or invalidated. Thus, the data retrieval request from a client device is routed from the independent node attached to the client device through other independent nodes prior to arriving at the independent node storing the requested data. It is possible that a data retrieval request will reach an independent node that has cached the requested data prior to reaching the independent node that has the requested data stored in a mass storage device. The dynamic caching of the scalable distributed storage apparatus 48 provides for efficient data retrieval by allowing data retrieval of requested data from independent nodes other than those that are storing the requested data on a mass storage device.

Referring to FIG. 9, the scalable distributed storage apparatus 48 handles a data storage or data update request from a client device in the following manner. A client device 60 inputs a new data set into the scalable distributed storage apparatus 48. The new data set can be stored at the independent node 66c to which the client device 60 is attached, or it may be stored in one of the other independent nodes 66. The data list at the independent node storing the new data set is updated accordingly. Subsequent to the updating of the data list, the client device 60 receives a notification that the new data set was successfully stored.

If the client device 60 inputs a new data set into the scalable distributed storage apparatus 48 that updates previously stored data, any previously cached data resident on the independent nodes must be either updated or invalidated prior to the client device receiving a notification that the new data set has been stored. If the previously cached data resident on the independent nodes is to be updated, the data lists on the independent nodes are searched for cached data, and if cached data corresponding to the new data set is found, the cached data is updated accordingly by the new data set. The list of nodes having a copy of the data stored thereon is maintained by the node having the storage device with the original data set. This list may be stored on other nodes as well. Only a subset of the nodes is searched for the cached data. The minimum set of nodes searched is exactly the nodes that store a copy of the data set. Subsequent to the updating of the cached data, the client device 60 receives a notification that the new data set was successfully stored. If the previously cached data resident on the independent nodes is to be invalidated, the data list of the independent nodes are searched for cached data, and if cached data to be invalidated is found, the cached data is invalidated. The updated data is stored on the mass storage device of one of the independent nodes. Subsequent to the invalidating of the cached data, the client device 60 receives a notification that the new data set was successfully stored.

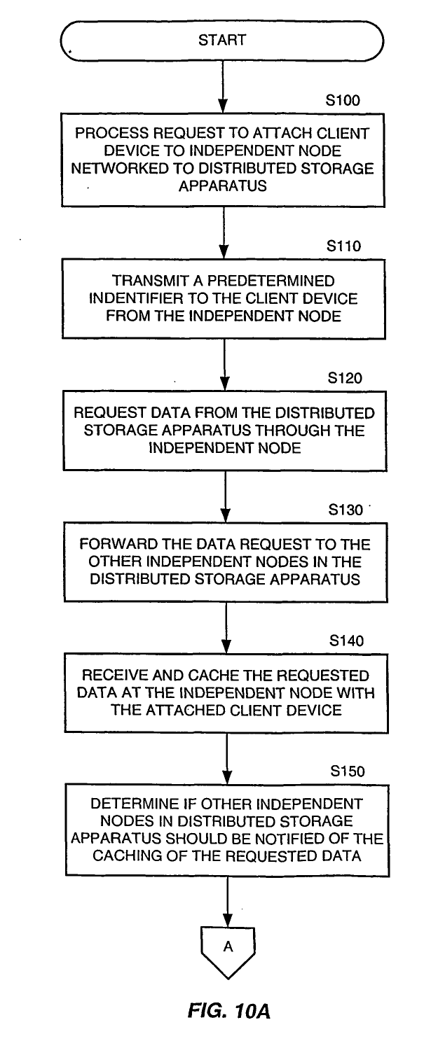

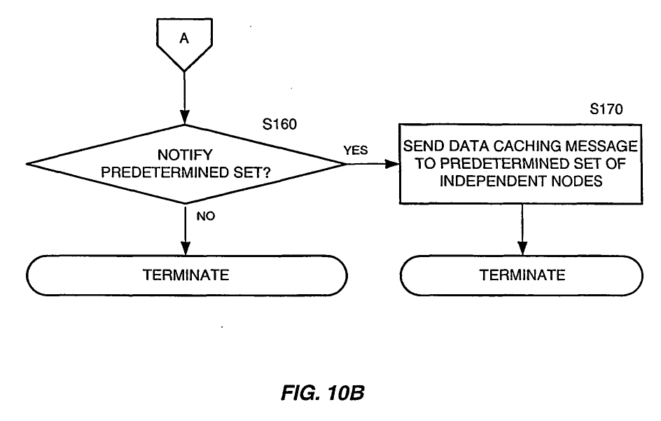

Referring to FIGS. 10A-10B, another aspect of the present invention is a method of handling data on a scalable distributed storage apparatus that comprises a plurality of independent nodes. The scalable distributed storage apparatus can process data requests from a plurality of client devices simultaneously.

Referring to FIG. 10A, at S100, an independent node processes a request from a client device to attach to the independent node. Both the client device and the independent node are described above, and the attachment process establishes a communications link between the client device and the independent node.

At S110, a predetermined identifier is transmitted to the client device when the client device attaches to the independent nodes. The client device is the initiator of the request for the predetermined identifier. The client device uses the predetermined identifier in order to access the scalable distributed storage service for both read and write operations. The same predetermined identifier is used independently of the accessed independent node. The independent nodes use the same predetermined identifier when responding to the client requests in order to identify itself. Thus, each independent node uniformly responds to each client device that attaches to the scalable distributed storage apparatus 48 with an identifier unique to the scalable distributed storage apparatus 48. From the perspective of the client device, there does not appear to be any difference to which independent node it attaches. In addition, the client device does not need to know different addresses in order to be able to reach different mass storage islands. Each independent node will respond with the identical identifier to any client device that attaches to the scalable distributed storage apparatus 48. Each independent node will have the same name, address or other identification address (e.g., DNS address).

Next, at S120, the client device requests data from the scalable distributed storage apparatus through the independent node to which the client device is attached, and at S130, the data request is forwarded to the rest of the independent nodes comprising the scalable distributed storage apparatus. The data request is compared against the data lists on the independent nodes. A list of independent nodes having a copy of the data stored thereon is maintained by the independent node having the storage device with the original data set. This list may be stored on other independent nodes as well. Only a subset of the independent nodes is searched for the cached data. The minimum set of independent nodes searched is exactly the independent nodes that store a copy of the data set. At S140, any data on the data list that matches the data request is forwarded to the independent node from which the data request originated. The requested data is cached at the receiving independent node.

At S150, a determination is made whether other independent nodes should be notified of the caching of the requested data. Referring to FIG. 10B, at S160, if the determination requires that a data caching notification should be sent to a subset of independent nodes, the process control shifts to S170. At S170, a data caching notification is sent to the independent nodes comprising the subset. For example, in rare cases, the subset can comprise all the independent nodes directly connected to the independent node caching the requested data. More commonly, the subset comprises independent nodes that are “nearest neighbors” or a random grouping of the independent nodes.

Another aspect of the present invention is a computer program product for processing data requests on a scalable distributed storage apparatus comprising a plurality of independent nodes. The software instructions on the computer program product allow the scalable distributed storage apparatus to process data requests from a plurality of client devices simultaneously.

The software instructions on the computer program product allow an independent node to process a request from a client device to attach to the independent node. Both the client device and the independent node are described above, and the attachment process establishes a communications link between the client device and the independent node.

The software instructions on the computer program product allow the independent node to transmit a predetermined identifier to the client device when the client device attaches to the independent nodes. The client device is the initiator of the request for the predetermined identifier. The client device uses the predetermined identifier in order to access the scalable distributed storage apparatus for data storage operations. The same predetermined identifier is used independently of the accessed independent node. The independent nodes use the same predetermined identifier when responding to the client requests in order to identify itself. Thus, each independent node uniformly responds to each client device that attaches to the scalable distributed storage apparatus 48 with an identifier unique to the scalable distributed storage apparatus 48. From the perspective of the client device, there does not appear to be any difference to which independent node it attaches. In addition, the client device does not need to know different addresses in order to be able to reach different mass storage islands. The software instructions on the computer program product allow each independent node to respond with the identical identifier to any client device that attaches to the scalable distributed storage apparatus 48. Each independent node will have the same name, address or other identification address (e.g., DNS address).

When the client device requests data from the scalable distributed storage apparatus through the independent node to which the client device is attached, the software instructions of the computer program product forward the data request is forwarded to the rest of the independent nodes comprising the scalable distributed storage apparatus. The data request is compared against the data lists on the independent nodes. A list of independent nodes having a copy of the data stored thereon is maintained by the independent node having the storage device with the original data set. This list may be stored on other independent nodes as well. Only a subset of the independent nodes is searched for the cached data The minimum set of independent nodes searched is exactly the independent nodes that store a copy of the data set. The software instructions on the computer program product match any data on the data list to the data request and the requested data is forwarded to the independent node from which the data request originated. The requested data is cached at the receiving independent node.

The software instructions of the computer program product allow a determination is made whether other independent nodes should be notified of the caching of the requested data. If the determination requires that a data caching notification should be sent to the other independent nodes, the software instructions sends a data caching notification to all the independent nodes.

If the determination requires that a data caching notification should be sent to a subset of independent nodes, the software instructions of the computer program product sends a data caching notification is sent to the independent nodes that comprise the subset. For example, in rare cases, the subset can comprise all the independent nodes directly connected to the independent node caching the requested data. More commonly, the subset comprises independent nodes that are “nearest neighbors” or a random grouping of the independent nodes.

Another aspect of the present invention is an executable program for an independent node in a scalable distributed storage apparatus comprising a plurality of independent nodes. The executable program allows the independent node on the scalable distributed storage apparatus to process data requests. A first executable portion of the executable program allows an independent node to process a request from a client device to attach to the independent node. Both the client device and the independent node are described above, and the attachment process establishes a communications link between the client device and the independent node.

A second executable portion of the executable program allows the independent node to transmit a predetermined identifier to the client device when the client device attaches to the independent nodes. The client device is the initiator of the request for the predetermined identifier. The client device uses the predetermined identifier in order to access the scalable distributed storage apparatus for data storage operations. The same predetermined identifier is used independently of the accessed independent node. The independent nodes use the same predetermined identifier when responding to the client requests in order to identify itself. Thus, each independent node uniformly responds to each client device that attaches to the scalable distributed storage apparatus 48 with an identifier unique to the scalable distributed storage apparatus 48. From the perspective of the client device, there does not appear to be any difference to which independent node it attaches. In addition, the client device does not need to know different addresses in order to be able to reach different mass storage islands. The second executable portion of the executable program allows each independent node to respond with the identical identifier to any client device that attaches to the scalable distributed storage apparatus 48. Each independent node will have the same name, address or other identification address (e.g., DNS address).

When the client device requests data from the scalable distributed storage apparatus through the independent node to which the client device is attached, the third executable portion of the executable program forwards the data request to the rest of the independent nodes comprising the scalable distributed storage apparatus. The data request is compared against the data lists on the independent nodes. A list of independent nodes having a copy of the data stored thereon is maintained by the independent node having the storage device with the original data set. This list may be stored on other independent nodes as well. Only a subset of the independent nodes is searched for the cached data. The minimum set of independent nodes searched is exactly the independent nodes that store a copy of the data set. The fourth executable portion of the executable program matches any data on the data list to the data request and the fifth executable portion of the executable program forwards the retrieved data to the independent node from which the data request originated. The requested data is cached at the receiving independent node.

The sixth portion of the executable program allows a determination is made whether other independent nodes should be notified of the caching of the requested data. If the determination requires that a data caching notification should be sent to the other independent nodes, the software instructions send a data caching notification to a subset of independent nodes, the sixth portion of the executable program sends a data caching notification is sent to the independent nodes that comprise the subset. For example, in rare cases, the subset can comprise all the independent nodes directly connected to the independent node caching the requested data. More commonly, the subset comprises independent nodes that are “nearest neighbors” or a random grouping of the independent nodes.

Another aspect of the present invention is an executable program for an independent node in a scalable distributed storage apparatus comprising a plurality of independent nodes. The executable program allows the independent node on the scalable distributed storage apparatus to process data requests.

The software means of the executable program allow an independent node to process a request from a client device to attach to the independent node. Both the client device and the independent node are described above, and the attachment process establishes a communications link between the client device and the independent node.

The software means of the executable program allow the independent node to transmit a predetermined identifier to the client device when the client device attaches to the independent nodes. The client device is the initiator of the request for the predetermined identifier. The client device uses the predetermined identifier in order to access the scalable distributed storage apparatus for data storage operations. The same predetermined identifier is used independently of the accessed independent node. The independent nodes use the same predetermined identifier when responding to the client requests in order to identify itself. Thus, each independent node uniformly responds to each client device that attaches to the scalable distributed storage apparatus 48 with an identifier unique to the scalable distributed storage apparatus 48. From the perspective of the client device, there does not appear to be any difference to which independent node it attaches. In addition, the client device does not need to know different addresses in order to be able to reach different mass storage islands. The software means of the executable program allow each independent node to respond with the identical identifier to any client device that attaches to the scalable distributed storage apparatus 48. Each independent node will have the same name, address or other identification address (e.g., DNS address).

When the client device requests data from the scalable distributed storage apparatus through the independent node to which the client device is attached, the software means of the executable program forward the data request is forwarded to the rest of the independent nodes comprising the scalable distributed storage apparatus. The data request is compared against the data lists on the independent nodes. A list of independent nodes having a copy of the data stored thereon is maintained by the independent node having the storage device with the original data set. This list may be stored on other independent nodes as well. Only a subset of the independent nodes is searched for the cached data. The minimum set of independent nodes searched is exactly the independent nodes that store a copy of the data set. The software means of the executable program match any data on the data list to the data request, and the data is forwarded to the independent node from which the data request originated. The requested data is cached at the receiving independent node.

The software means of the executable program allow a determination is made whether other independent nodes should be notified of the caching of the requested data. If the determination requires that a data caching notification should be sent to the other independent nodes, the software means of the executable program sends a data caching notification is sent to the independent nodes that comprise the subset. For example, in rare cases, the subset can comprise all the independent nodes directly connected to the independent node caching the requested data. More commonly, the subset comprises independent nodes that are “nearest neighbors” or a random grouping of the independent nodes.

Another aspect of the present invention is a method of handling data storage requests on a scalable distributed storage apparatus comprising a plurality of independent nodes. The method provides for storing data on the scalable distributed storage apparatus received from a plurality of client devices attached to the independent nodes.

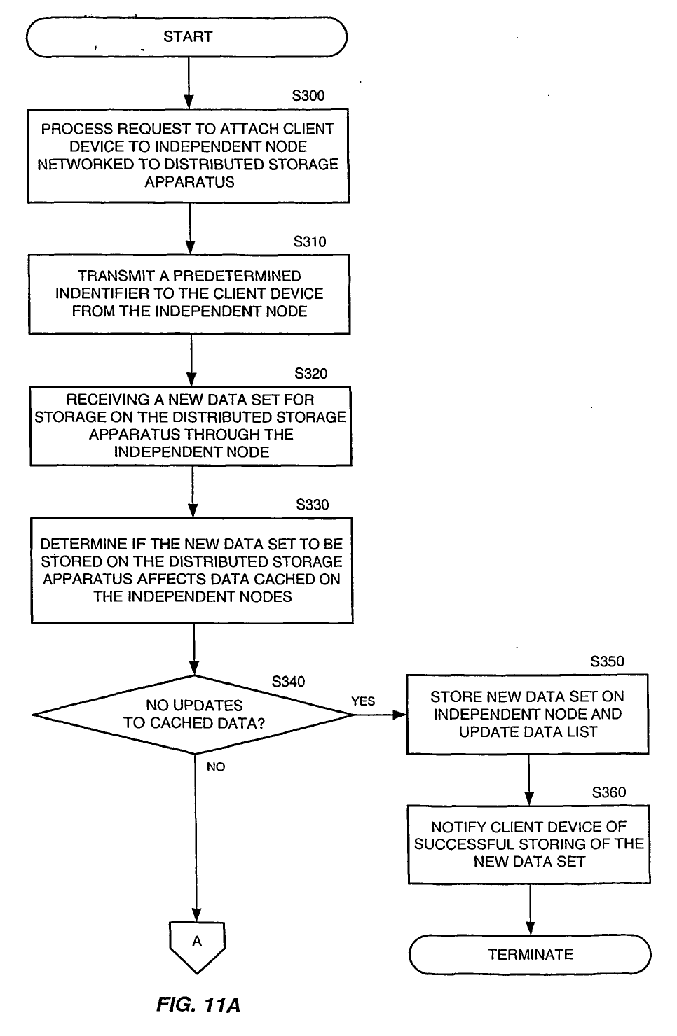

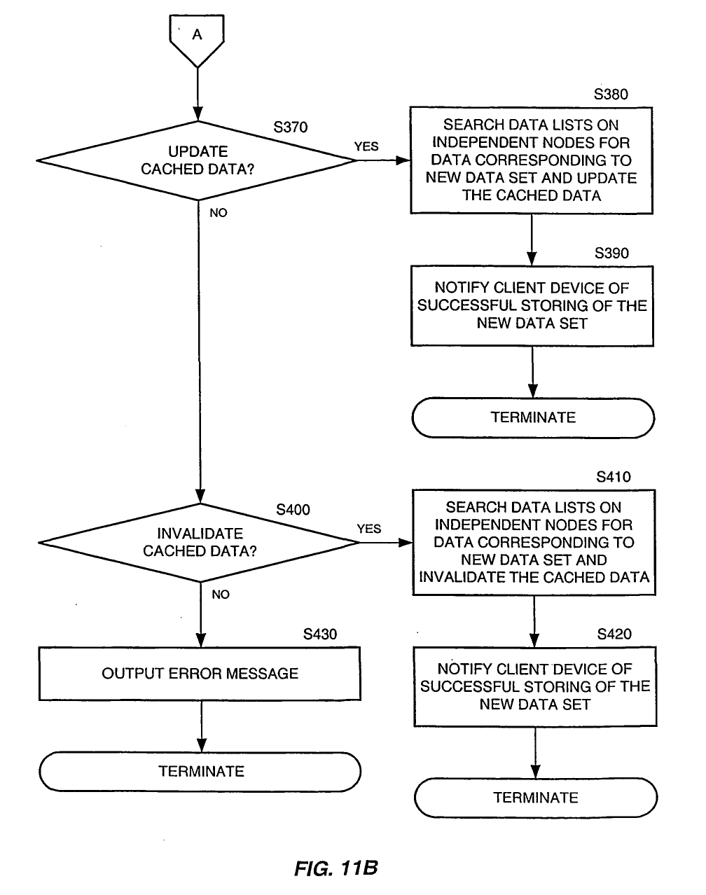

Referring to FIG. 11A, at S300, an independent node processes a request from a client device to attach to the independent node. Both the client device and the independent node are described above, and the attachment process establishes a communications link- between the client device and the independent node.

At S310, a predetermined identifier is transmitted to the client device when the client device attaches to the independent node. The client device is the initiator of the request for the predetermined identifier. The client device uses the predetermined identifier in order to access the scalable distributed storage apparatus for data storage operations. The same predetermined identifier is used independently of the accessed independent node. The independent nodes use the same predetermined identifier when responding to the client requests when identifying itself. Thus, each independent node uniformly responds to each client device that attaches to the scalable distributed storage apparatus 48 with an identifier unique to the scalable distributed storage apparatus 48. From the perspective of the client device, there does not appear to be any difference to which independent node it attaches. In addition, the client device does not need to know different addresses in order to be able to reach different mass storage islands. Each independent node will respond with the identical identifier to any client device that attaches to the scalable distributed storage apparatus 48. Each independent node will have the same name, address or other identification address (e.g., DNS address).

At S320, the independent node to which the client device has attached receives a new data set from the client device. This data set may comprise entirely new data to the stored on the scalable distributed storage apparatus, it may comprise updates to data already stored on the scalable distributed storage apparatus, or it may be a combination of new data and updates to previously stored data. At S330, a determination is made into which category the new data set falls.

At S340, if the new data set is entirely new data to be stored, then the method continues to S350, wherein the new data set is stored on the independent node to which the client device that input the new data set is attached. The new data set could be stored on other independent nodes or network storage devices comprising the scalable distributed storage apparatus as well. In addition, the present invention does not require that the new data set be stored at a single independent node or network storage device. If necessary, the new data set could be broken up and distributed amongst the independent nodes and network storage devices. After the storage of the new data set is complete, at S360, a notification is sent to the inputting client device that the storage was successful. If the new data set is not entirely new data to be stored, the method continues to S370.

Referring to FIG. 11B, if the new data set requires cached data to be updated, then the method continues to S380, where the data lists on the independent nodes are searched for cached data corresponding to the new data set. A list of independent nodes having a copy of the data stored thereon is maintained by the independent node having the storage device with the original data set. This list may be stored on other independent nodes as well. Only a subset of the independent nodes is searched for the cached data. The minimum set of independent nodes searched is exactly the independent nodes that store a copy of the data set. If found, the cached data is updated accordingly. After the updating of the cached data is complete on all the independent nodes, at S390, a notification is sent to the inputting client device that the storage was successful. If the new data set does not require updating cached data, the method continues to S400.

At S400, if the new data set requires cached data to be invalidated, then the method continues to S410, where the data lists on the independent nodes are searched for cached data corresponding to the new data set. If found, the cached data is invalidated so that it is no longer used. Any subsequent data retrieval requests will ignore the invalidated cached data. After the invalidating of the cached data is complete on all the independent nodes, at S420, a notification is sent to the inputting client device that the storage was successful. If the new data set does not require invalidating cached data, the method continues to S430 where an error message is output.

Another aspect of the present invention is a computer program product for handling data storage requests on a scalable distributed storage apparatus comprising a plurality of independent nodes. The software instructions on the computer program product provide for storing data on the scalable distributed storage apparatus received from a plurality of client devices attached to the independent nodes.

The software instructions on the computer program product allow an independent node processes a request from a client device to attach to the independent node. Both the client device and the independent node are described above, and the attachment process establishes a communications link between the client device and the independent node.

The software instructions on the computer program product allow a predetermined identifier to be transmitted to the client device when the client device attaches to the independent node. The client device is the initiator of the request for the predetermined identifier. The client device uses the predetermined identifier in order to access the scalable distributed storage apparatus for data storage operations. The same predetermined identifier is used independently of the accessed independent node. The independent nodes use the same predetermined identifier when responding to the client requests when identifying itself. Thus, each independent node uniformly responds to each client device that attaches to the scalable distributed storage apparatus 48 with an identifier unique to the scalable distributed storage apparatus 48. From the perspective of the client device, there does not appear to be any difference to which independent node it attaches. In addition, the client device does not need to know different addresses in order to be able to reach different mass storage islands. Each independent node will respond with the identical identifier to any client device that attaches to the scalable distributed storage apparatus 48. Each independent node will have the same name, address or other identification address (e.g., DNS address).

The software instructions on the computer program product allow the independent node to which the client device has attached receives a new data set from the client device. This data set may comprise entirely new data to the stored on the scalable distributed storage apparatus, it may comprise updates to data already stored on the scalable distributed storage apparatus, or it may be a combination of new data and updates to previously stored data. The software instructions on the computer program product allow a determination is made into which category the new data set falls.

If the new data set is entirely new data to be stored, then the software instructions on the computer program product stores the new data set on the independent node to which the client device that input the new data set is attached. The new data set could be stored on other independent nodes or network storage devices comprising the scalable distributed storage apparatus as well. In addition, the present invention does not require that the new data set be stored at a single independent node or network storage device. If necessary, the new data set could be broken up and distributed amongst the independent nodes and network storage devices. After the storage of the new data set is complete, the software instructions on the computer program product send a notification is sent to the inputting client device that the storage was successful.

If the new data set requires cached data to be updated, then the software instructions on the computer program product searches the data lists on the independent nodes for cached data corresponding to the new data set. A list of independent nodes having a copy of the data stored thereon is maintained by the independent node having the storage device with the original data set. This list may be stored on other independent nodes as well. Only a subset of the independent nodes is searched for the cached data. The minimum set of independent nodes searched is exactly the independent nodes that store a copy of the data set. If found, the cached data is updated accordingly. After the updating of the cached data is complete on all the independent nodes, the software instructions on the computer program product sends a notification to the inputting client device that the storage was successful.

If the new data set requires cached data to be invalidated, then the software instructions on the computer program product search the data lists on the independent nodes for cached data corresponding to the new data set. If found, the cached data is invalidated so that it is no longer used. Any subsequent data retrieval requests will ignore the invalidated cached data. After the invalidating of the cached data is complete on all the independent nodes, the software instructions on the computer program product sends a notification to the inputting client device that the storage was successful. If the new data set does not require invalidating cached data, the software instructions on the computer program product output an error message.

Another aspect of the present invention is an executable program for handling data storage requests on a scalable distributed storage apparatus comprising a plurality of independent nodes. The executable program allows the independent node on the scalable distributed storage apparatus to store data on the scalable distributed storage apparatus received from a plurality of client devices attached to the independent nodes.

The first executable portion of the executable program allows an independent node to process a request from a client device to attach to the independent node. Both the client device and the independent node are described above, and the attachment process establishes a communications link between the client device and the independent node.

The second executable portion of the executable program allows a predetermined identifier to be transmitted to the client device when the client device attaches to the independent node. The client device is the initiator of the request for the predetermined identifier. The client device uses the predetermined identifier in order to access the scalable distributed storage apparatus for data storage operations. The same predetermined identifier is used independently of the accessed independent node. The independent nodes use the same predetermined identifier when responding to the client requests in order to identify itself. Thus, each independent node uniformly responds to each client device attached to the scalable distributed storage apparatus 48 with an identifier unique to the scalable distributed storage apparatus 48. From the perspective of the client device, there does not appear to be any difference to which independent node it attaches. In addition, the client device does not need to know different addresses in order to be able to reach different mass storage islands. Each independent node will respond with the identical identifier to any client device that attaches to the scalable distributed storage apparatus 48. Each independent node will have the same name, address or other identification address (e.g., DNS address).

The third executable portion of the executable program allows the independent node to which the client device has attached to receive a new data set from the client device. This data set may comprise entirely new data to the stored on the scalable distributed storage apparatus, it may comprise updates to data already stored on the scalable distributed storage apparatus, or it may be a combination of new data and updates to previously stored data. The software instructions on the computer program product allow a determination is made into which category the new data set falls.

If the new data set is entirely new data to be stored, then the fourth executable portion of the executable program stores the new data set on the independent node to which the client device that input the new data set is attached. The new data set could be stored on other independent nodes or network storage devices comprising the scalable distributed storage apparatus as well. In addition, the present invention does not require that the new data set be stored at a single independent node or network storage device. If necessary, the new data set could be broken up and distributed amongst the independent nodes and network storage devices. After the storage of the new data set is complete, the fifth executable portion of the executable program sends a notification is sent to the inputting client device that the storage was successful.

If the new data set requires cached data to be updated, then the fourth executable portion of the executable program searches the data lists on the independent nodes for cached data corresponding to the new data set. A list of independent nodes having a copy of the data stored thereon is maintained by the independent node having the storage device with the original data set. This list may be stored on other independent nodes as well. Only a subset of the independent nodes is searched for the cached data. The minimum set of independent nodes searched is exactly the independent nodes that store a copy of the data set. If found, the cached data is updated accordingly. After the updating of the cached data is complete on all the independent nodes, the fifth executable portion of the executable program sends a notification to the inputting client device that the storage was successful.

If the new data set requires cached data to be invalidated, then the fourth executable portion of the executable program searches the data lists on the independent nodes for cached data corresponding to the new data set. If found, the cached data is invalidated so that it is no longer used. Any subsequent data retrieval requests will ignore the invalidated cached data. After the invalidating of the cached data is complete on all the independent nodes, the fifth executable portion of the executable program sends a notification to the inputting client device that the storage was successful. If the new data set does not require invalidating cached data, the software instructions on the computer program product output an error message.

Another aspect of the present invention is an executable program for handling data storage requests on a scalable distributed storage apparatus comprising a plurality of independent nodes. The executable program comprises software means for storing data on the scalable distributed storage apparatus received from a plurality of client devices attached to the independent nodes.

The executable program has software means for allowing an independent node to process a request from a client device to attach to the independent node. Both the client device and the independent node are described above, and the attachment process establishes a communications link between the client device and the independent node.

The executable program has software means for allowing a predetermined identifier to be transmitted to the client device when the client device attaches to the independent node. The client device is the initiator of the request for the predetermined identifier. The client device uses the predetermined identifier in order to access the scalable distributed storage apparatus for data storage operations. The same predetermined identifier is used independently of the accessed independent node. The independent nodes use the same predetermined identifier when responding to the client requests in order to identify itself. Thus, each independent node uniformly responds to each client device attached to the scalable distributed storage apparatus 48 with an identifier unique to the scalable distributed storage apparatus 48. From the perspective of the client device, there does not appear to be any difference to which independent node it attaches. In addition, the client device does not need to know different addresses in order to be able to reach different mass storage islands. Each independent node will respond with the identical identifier to any client device that attaches to the scalable distributed storage apparatus 48. Each independent node will have the same name, address or other identification address (e.g., DNS address).

The executable program has software means for allowing the independent node to which the client device has attached to receive a new data set from the client device. This data set may comprise entirely new data to the stored on the scalable distributed storage apparatus, it may comprise updates to data already stored on the scalable distributed storage apparatus, or it may be a combination of new data and updates to previously stored data. The software means allow a determination is made into which category the new data set falls.

If the new data set is entirely new data to be stored, then the software means stores the new data set on the independent node to which the client device that input the new data set is attached. The new data set could be stored on other independent nodes or network storage devices comprising the scalable distributed storage apparatus as well. In addition, the present invention does not require that the new data set be stored at a single independent node or network storage device. If necessary, the new data set could be broken up and distributed amongst the independent nodes and network storage devices. After the storage of the new data set is complete, the software means of the executable program sends a notification is sent to the inputting client device that the storage was successful.

If the new data set requires cached data to be updated, then the executable program has software means for searching the data lists on the independent nodes for cached data corresponding to the new data set. A list of independent nodes having a copy of the data stored thereon is maintained by the independent node having the storage device with the original data set. This list may be stored on other independent nodes as well. Only a subset of the independent nodes is searched for the cached data. The minimum set of independent nodes searched is exactly the independent nodes that store a copy of the data set. If found, the cached data is updated accordingly. After the updating of the cached data is complete on all the independent nodes, the software means sends a notification to the inputting client device that the storage was successful.

If the new data set requires cached data to be invalidated, then the executable program has software means for searching the data lists on the independent nodes for cached data corresponding to the new data set. If found, the cached data is invalidated so that it is no longer used. Any subsequent data retrieval requests will ignore the invalidated cached data. After the invalidating of the cached data is complete on all the independent nodes, the software means sends a notification to the inputting client device that the storage was successful. If the new data set does not require invalidating cached data, the software means on the computer program product output an error message.

The foregoing description of the aspects of the invention has been presented for purposes of illustration and description. It is not intended to be exhaustive or to limit the invention to the precise form disclosed, and modifications and variations are possible in light of the above teachings or may be acquired from practice of the invention. The principles of the invention and its practical application were described in order to explain the to enable one skilled in the art to utilize the invention in various embodiments and with various modifications as are suited to the particular use contemplated.

Thus, while only certain aspects of the invention have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. A scalable distributed storage apparatus comprising a network, the apparatus further comprising:
a plurality of independent nodes connected to each other through the network, each independent node comprising at least one storage device;
wherein each independent node responds with the same identifier when a client device attaches to any one independent node from the plurality of independent nodes.

2. The scalable distributed storage apparatus as claimed in claim 1, wherein each independent node is a server.

3. The scalable distributed storage apparatus as claimed in claim 1, wherein the at least one storage device is a disk device.

4. The scalable distributed storage apparatus as claimed in claim 1, wherein the at least one storage device is a redundant array of independent disks device.

5. The scalable distributed storage apparatus as claimed in claim 1, wherein communications protocol between the attached-client device and the independent node to which the client device is attached is the InfiniBand protocol.

6. The scalable distributed storage apparatus as claimed in claim 1, further comprising at least one network storage device is connected to the network independent of the plurality of independent nodes.

7. The scalable distributed storage apparatus as claimed in claim 6, wherein the communications protocol between the plurality of independent nodes and the at least one network storage device is the InfiniBand protocol.

8. The scalable distributed storage apparatus as claimed in claim 1, wherein a data retrieval request from the attached client device is routed to the independent node storing the requested data.

9. The scalable distributed storage apparatus as claimed in claim 8, wherein the independent node caching the requested data broadcasts a data caching notification to a subset of independent nodes.

10. The scalable distributed storage apparatus as claimed in claim 8, wherein the subset of independent nodes is a random grouping of independent nodes.

11. The scalable distributed storage apparatus as claimed in claim 10, wherein the subset of independent nodes are those independent nodes directly connected to the independent node caching the requested data.

12. The scalable distributed storage apparatus as claimed in claim 1, wherein an independent node receiving new data input from the attached client device notifies the attached client device when the new data has been successfully stored.

13. The scalable distributed storage apparatus as claimed in claim 1, wherein an independent node receiving updated data input from the attached client device that affects previously stored data notifies the attached client device that the updated data has been successfully stored only after all cached copies of the previously stored data have been invalidated.

14. The scalable distributed storage apparatus as claimed in claim 1, wherein an independent node receiving updated data input from the attached client device that affects previously stored data notifies the attached client device that the updated data has been successfully stored only after all cached copies of the previously stored data have been updated.

15. A scalable distributed storage apparatus comprising a network, the apparatus further comprising:
a plurality of independent nodes connected to each other through the network;
a plurality of network storage devices connected to each other and the plurality of independent nodes through the network;
wherein each independent node responds with the same identifier when a client device attaches to any one independent node from the plurality of independent nodes.

16. The scalable distributed storage apparatus as claimed in claim 15, wherein each independent node is a server.

17. The scalable distributed storage apparatus as claimed in claim 15, wherein at least one independent node comprises a redundant array of independent disks device.

18. The scalable distributed storage apparatus as claimed in claim 15, wherein communications protocol between the attached client device and the independent node to which the client device is attached is the InfiniBand protocol.

19. The scalable distributed storage apparatus as claimed in claim 15, wherein the communications protocol between the plurality of independent nodes and the plurality of network storage devices is the InfiniBand protocol.

20. The scalable distributed storage apparatus as claimed in claim 15, wherein a data request from the attached client device is routed to the independent node storing the requested data.

21. The scalable distributed storage apparatus as claimed in claim 20, wherein the independent node caching the requested data broadcasts a data caching notification to a subset of independent nodes.

22. The scalable distributed storage apparatus as claimed in claim 21, wherein the subset of independent nodes is a random grouping of the plurality of independent nodes.

23. The scalable distributed storage apparatus as claimed in claim 21, wherein the subset of independent nodes are those independent nodes directly connected to the independent node caching the requested data.

24. The scalable distributed storage apparatus as claimed in claim 15, wherein an independent node receiving new data input from the attached client device notifies the attached client device when the new data input has been successfully stored.

25. The scalable distributed storage apparatus as claimed in claim 15, wherein an independent node, receiving updated data input from the attached client device that affects previously stored data, notifies the attached client device that the updated data input has been successfully stored only after all cached copies of the previously stored data have been invalidated.

26. The scalable distributed storage apparatus as claimed in claim 15, wherein an independent node receiving updated data input from the attached client device that affects previously stored data notifies the attached client device that the updated data has been successfully stored only after all cached copies of the previously stored data have been updated.

27. A scalable distributed storage apparatus comprising a network, the apparatus further comprising:
a plurality of independent computing means connected to each other through the network;
a plurality of network storage means connected to each other and the plurality of independent computing means through the network;
wherein each independent computing means responds with the same identifier when a client means attaches to any one independent computing means from the plurality of independent computing means.

28. A method of handling data on a scalable distributed storage apparatus comprising a plurality of independent nodes, wherein a plurality of client devices can attach to several of the independent nodes, the method comprising:
attaching a client device to an independent node;
transmitting a predetermined identifier to each of the client devices when the client device attaches to a selected one of the plurality of independent nodes;
requesting data from the scalable distributed storage apparatus through the independent node to which the client device is attached;
forwarding the data request to the plurality of independent nodes;
receiving the requested data from at least one of the plurality of independent nodes and caching the requested data at the independent node to which the requesting client device is attached; and
notifying at least one of the plurality of independent nodes of the location of the cached requested data.

29. The method as claimed in claim 28, wherein notifying other independent nodes further comprises notifying a subset of independent nodes of the location of the cached requested data.

30. The method as claimed in claim 29, wherein notifying a subset of independent nodes further comprises notifying a random grouping of the plurality of independent nodes.

31. The method as claimed in claim 29, wherein notifying a subset of independent nodes further comprises notifying those independent nodes directly connected to the independent node caching the requested data.

32. A computer program product for processing data requests on a scalable distributed storage apparatus comprising a plurality of independent nodes, wherein a plurality of client devices can attach to several of the independent nodes, the computer program product comprising:
software instructions for enabling an independent node to perform predetermined operations, and a computer readable medium bearing the software instructions;
the predetermined operations comprising:
processing an attachment request from a client device to the independent node;
transmitting a predetermined identifier to each of the client devices when the client device attaches to a selected one of the plurality of independent nodes;
processing a data request to the scalable distributed storage apparatus through the independent node to which the client device is attached;
forwarding the data request to the plurality of independent nodes;
receiving the requested data from at least one of the plurality of independent nodes and caching the requested data at the independent node to which the requesting client device is attached; and
notifying at least one of the plurality of independent nodes of the location of the cached requested data.

33. The computer program product as claimed in claim 32, wherein the predetermined operation of notifying other independent nodes further comprises notifying a subset of independent nodes of the location of the cached requested data.

34. The computer program product as claimed in claim 32, wherein notifying a subset of independent nodes further comprises notifying a random grouping of the plurality of independent nodes.

35. The computer program product as claimed in claim 32, wherein notifying a subset of independent nodes further comprises notifying the independent nodes directly connected to the independent node caching the requested data.

36. An executable program for an independent node in a scalable distributed storage apparatus, the executable program comprising:
a first executable code portion which, when executed on the independent node, processes an attachment request from a client device to the independent node;
a second executable code portion which, when executed on the independent node, transmits a predetermined identifier to the client device from the independent node, wherein the predetermined identifier is identical to the identifier transmitted to other attached client devices;
a third executable code portion which, when executed on the independent node, processes a data request to the scalable distributed storage apparatus through the independent node to which the client device is attached;
a fourth executable code portion which, when executed on the independent node, forwards the data request to the plurality of independent nodes;
a fifth executable code portion which, when executed on the independent node, receives the requested data from at least one of the plurality of independent nodes and caches the requested data at the independent node to which the requesting client device is attached; and
a sixth executable code portion which, when executed on the independent node, notifies at least one of the plurality of independent nodes of the location of the cached requested data.

37. An executable program for an independent node in a scalable distributed storage apparatus, the executable program comprising:
software means for attaching a client device to the independent node;
software means for a predetermined identifier to the client device from the independent node, wherein the predetermined identifier is identical to the identifier transmitted to other attached client devices;
software means for processing a data request to the scalable distributed storage apparatus through the independent node to which the client device is attached;
software means for forwarding the data request to the plurality of independent nodes;
software means for receiving the requested data from at least one of the plurality of independent nodes and caches the requested data at the independent node to which the requesting client device is attached; and
software means for notifying at least one of the plurality of independent nodes of the location of the cached requested data.

38. A computer system adapted to storing data from a plurality of storage systems on a storage medium, the computer system comprising:
a processor;
a memory comprising software instructions adapted to enable the computer system to perform the steps of:
processing an attachment request from a: client device to the computer system;
transmitting a predetermined identifier to the client device from the computer system, wherein the predetermined identifier is identical to the identifier transmitted to other attached client devices;
processing a data request to a scalable distributed storage apparatus through the computer system to which the client device is attached;
forwarding the data request to the scalable distributed storage apparatus;
receiving the requested data from the scalable distributed storage apparatus and caching the requested data at the computer system to which the requesting client device is attached; and
notifying the scalable distributed storage apparatus of the location of the cached requested data.

39. A method of handling data on a scalable distributed storage apparatus comprising a plurality of independent nodes, wherein a plurality of client devices can attach to several of the independent nodes, the method comprising:
attaching a client device to an independent node;
transmitting a predetermined identifier to the client device from the independent node, wherein the predetermined identifier is identical to the identifier transmitted to other attached client devices;
receiving a new data input from the client device attached to the scalable distributed storage apparatus through the independent node;
determining whether the new data input is new data to be stored or an update to previously stored data, and based on that determination, storing the new data input on the scalable distributed storage apparatus, if it is new data to be stored, or updating the previously stored data on the scalable distributed is storage apparatus, if it is an update to previously stored data; and
transmitting a notification to the attached client device if the storing of the new data input was successful.

40. The method as claimed in claim 39, wherein the updating the previously stored data on the scalable distributed storage apparatus further comprises invalidating all cached copies of the previously stored data, and storing the new data input on the scalable distributed storage apparatus.

41. The method as claimed in claim 40, wherein the transmitting a notification to the attached client device occurs after all cached copies of the previously stored data is invalidated.

42. The method as claimed in claim 39, wherein the updating the previously stored data on the scalable distributed storage apparatus further comprises replacing all cached copies of the previously stored data with the new data input.

43. The method as claimed in claim 42, wherein the transmitting a notification to the attached client device occurs after all cached copies of the previously stored data have been replaced.

44. A computer program product for processing data requests on a scalable distributed storage apparatus comprising a plurality of independent nodes, wherein a plurality of client devices can attach to several of the independent nodes, the computer program product comprising:
software instructions for enabling an independent node to perform predetermined operations, and a computer readable medium bearing the software instructions;
the predetermined operations comprising:
attaching a client device to an independent node;
transmitting a predetermined identifier to the client device from the independent node, wherein the predetermined identifier is identical to the identifier transmitted to other attached client devices;
receiving a new data input from the client device attached to the scalable distributed storage apparatus through the independent node;
determining whether the new data input is new data to be stored or an update to previously stored data, and based on that determination, storing the new data input on the scalable distributed storage apparatus, if it is new data to be stored, or updating the previously stored data on the scalable distributed storage apparatus, if it is an update to previously stored data; and
transmitting a notification to the attached client device if the storing of the new data input was successful.

45. The computer program product as claimed in claim 44, wherein the updating the previously stored data on the scalable distributed storage apparatus further comprises invalidating all cached copies of the previously stored data, and storing the new data input-on the scalable distributed storage apparatus.

46. The computer program product as claimed in claim 45, wherein the transmitting a notification to the attached client device occurs after all cached copies of the previously stored data is invalidated.

47. The computer program product as claimed in claim 44, wherein the updating the previously stored data on the scalable distributed storage apparatus further comprises replacing all cached copies of the previously stored data with the new data input.

48. The computer program product as claimed in claim 47, wherein the transmitting a notification to the attached client device occurs after all cached copies of the previously stored data have been replaced.

49. An executable program for an independent node in a scalable distributed storage apparatus, the executable program comprising:
a first executable code portion which, when executed on the independent node, processes an attachment request from client device to the independent node;
a second executable code portion which, when executed on the independent node, transmits a predetermined identifier to the client device from the independent node, wherein the predetermined identifier is identical to the identifier transmitted to other attached client devices;
a third executable code portion which, when executed on the independent node, receives a new data input from the client device attached to the scalable distributed storage apparatus through the independent node;
a fourth executable code portion which, when executed on the independent node, determines whether the new data input is new data to be stored or an update to previously stored data, and based on that determination, storing the new data input on the scalable distributed storage apparatus, if it is new data to be stored, or updating the previously stored data on the scalable distributed storage apparatus, if it is an update to previously stored data; and
a fifth executable code portion which, when executed on the independent node, transmits a notification to the attached client device if the storing of the new data input was successful.

50. An executable program for an independent node in a scalable distributed storage apparatus, the executable program comprising:
software means for attaching a client device to the independent node;
software means for transmitting a predetermined identifier to the client device from the independent node, wherein the predetermined identifier is identical to the identifier transmitted to other attached client devices;
software means for receiving a new data input from the client device attached to the scalable distributed storage apparatus through the independent node;
software means for determining whether the new data input is new data to be stored or an update to previously stored data, and based on that determination, storing the new data input on the scalable distributed storage apparatus, if it is new data to be stored, or updating the previously stored data on the scalable distributed storage apparatus, if it is an update to previously stored data; and
software means for transmitting a notification to the attached client device if the storing of the new data input was successful.

51. A computer system adapted to storing data from a plurality of storage systems on a storage medium, the computer system comprising:
a processor;
a memory comprising software instructions adapted to enable the computer system to perform the steps of:
attaching a client device to the computer system;
transmitting a predetermined identifier to the client device from the computer system, wherein the predetermined identifier is identical to the identifier transmitted to other attached client devices;
receiving a new data input from the client device attached to the computer system;
determining whether the new data input is new data to be stored or an update to previously stored data, and based on that determination, storing
